(19) United States
(12) Patent Application Publication
(10) Pub. No.: US 2011/0277866 A1
(43) Pub. Date: Nov. 17, 2011

(54) Apparatus and Method For Sealing A Ventilation Channel of A Pipe

(75) Inventors: Dave Downing, West Chester, OH (US); Roger Siferd, Findlay, OH (US); Nicholas Piazza, Bridgeport, OH (US); Stan Holowiecki, Trenton, OH (US); Howard Montgomery, Findlay, OH (US)

(73) Assignee: ADVANCED DRAINAGE SYSTEMS, Inc.

(21) Appl. No.: 12/779,634

(22) Filed: May 13, 2010

(51) Int. Cl. F16L 9/14; B23P 17/00; B23P 19/02

(52) U.S. Cl. 138/140; 29/525; 29/527.1

(57) ABSTRACT

A method of sealing a ventilation channel for a pipe is disclosed. The method includes inserting a sealing insert into a ventilation hole of the ventilation channel, applying rotational energy to the sealing insert, deactivating the rotational energy to the sealing insert once the sealing insert reaches a threshold position, and separating a first portion of the sealing insert being inserted in the ventilation channel from a second portion of the sealing insert.

### FIELD OF THE DISCLOSURE

The present disclosure is related to a corrugated pipe, and more particularly, to an apparatus and method for sealing a ventilation channel of a corrugated pipe.

### BACKGROUND OF THE DISCLOSURE

Generally speaking, drainage systems may employ corrugated pipes to collect and convey fluids and debris to desired locations in various agricultural, residential, recreational, or civil engineering and construction applications. Such corrugated pipes may typically be formed via extrusion processes, where, for example, a vacuum is often used to draw molten material into a mold to form corrugations. In one example, a corrugated pipe may be manufactured by co-extruding a smooth inner pipe wall and an outer pipe wall having a plurality of corrugations. As a result, hollow chambers may be formed between the inner pipe wall and each corrugation of the outer pipe wall.

As the corrugated pipe is released from the mold, the molten material begins to cool. Accordingly, hot air or gas contained within each chamber also cools, becoming more dense and ultimately creating a partial vacuum. In some instances, this partial vacuum formed in each sealed chamber may create undesirable deforming forces, causing, among other things, the molded corrugations to warp or collapse.

One contemplated remedy for such an undesirable vacuum includes, for example, puncturing one or more ventilation holes into each corrugation to allow ambient air to enter the chambers as the air or gas therein cools down. However, puncturing each corrugation may weaken the outer surface of the pipe, making the pipe susceptible to damage and failure from applied loads and pressures to the outer surface.

Alternatively, one or more ventilation channels may be formed between each corrugation and serially extend along the length of the corrugated pipe, terminating with openings at the terminal ends of the corrugated pipe. Accordingly, as hot air in each chamber cools down and undergoes the above-described vacuuming effect, ambient air is “sucked in” to each chamber through the vent channels, thereby preventing deformation and collapse of the corrugations.

Although such ventilation channels may be advantageous in corrugated pipe production, they do have certain limitations. One problem is associated with sealing the ventilation channels. In use, the ventilations channels must be sealed from the outside environment. This is necessary to prevent entry of fluid and debris into the chambers of the corrugations through the ventilation channels. Entry of contaminants, such as fluid and debris, into the chambers may undesirably damage or deform, for example, the inner pipe wall and/or the corrugation of the outer pipe wall.

Contemplated seals include, for example, adhesives and plastic welds. Such seals, however, may be deficient at least in terms of strength and consistency, and also may take an undesirably excessive amount of time to dry or cure.

Accordingly, the sealing insert of the present disclosure is directed to improvements in the existing technology.

### SUMMARY OF THE DISCLOSURE

One exemplary aspect of the present disclosure is directed to a method of sealing a ventilation channel for a pipe. The method may include inserting a sealing insert into a ventilation hole of the ventilation channel, applying rotational energy to the sealing insert, deactivating the rotational energy to the sealing insert once the sealing insert reaches a threshold position, and separating a first portion of the sealing insert being inserted in the ventilation channel from a second portion of the sealing insert.

Another exemplary aspect of the present disclosure is directed to a corrugated pipe. The corrugated pipe may include an inner wall, an outer wall including a plurality of corrugations, a ventilation channel formed between the inner wall and the outer wall, and a sealing insert secured within the ventilation channel, the sealing insert configured to fluidly seal the ventilation channel.

Yet another exemplary aspect of the present disclosure is directed to a method for manufacturing a pipe. The method may include co-extruding an inner pipe wall and a corrugated outer pipe wall from a mold to form a corrugated pipe, the corrugated outer pipe wall including a plurality of corrugations. The method may further include forming a ventilation channel extending through and in communication with each of the plurality of corrugations, the ventilation channel including at least one ventilation hole, and releasing the corrugated pipe from the mold. Moreover, the method may include sealing the ventilation channel by securing a sealing insert within the ventilation channel after the corrugated pipe is released from the mold.

In this respect, before explaining at least one embodiment of the present disclosure in detail, it is to be understood that the present disclosure is not limited in its application to the details of construction and to the arrangements of the components set forth in the following description or illustrated in the drawings. The present disclosure is capable of embodiments in addition to those described and of being practiced and carried out in various ways. Also, it is to be understood that the phraseology and terminology employed herein, as well as the abstract, are for the purpose of description and should not be regarded as limiting.

The accompanying drawings illustrate certain exemplary embodiments of the present disclosure, and together with the description, serve to explain the principles of the present disclosure.

As such, those skilled in the art will appreciate that the conception upon which this disclosure is based may readily be used as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

FIG. 1 is a partial view of a corrugated pipe according to an exemplary disclosed embodiment;

FIG. 2 is another view of the corrugated pipe of FIG. 1 according to an exemplary disclosed embodiment

FIG. 3 is a partial, cross-sectional view of the corrugated pipe of FIG. 1 taken along dashed line “A” of FIG. 2 according to an exemplary disclosed embodiment;

FIG. 4A is a view of a sealing insert for sealing a ventilation channel of a corrugated pipe according to an exemplary disclosed embodiment;

FIG. 4B is a view of a sealing insert for sealing a ventilation channel of a corrugated pipe according to an alternative exemplary disclosed embodiment;

FIG. 4C is a view of a sealing insert for sealing a ventilation channel of a corrugated pipe according to an alternative exemplary disclosed embodiment;

FIG. 4D is a view of a sealing insert for sealing a ventilation channel of a corrugated pipe according to an alternative exemplary disclosed embodiment;

FIG. 5 is a depiction of the sealing insert of FIG. 2A inserted within the ventilation channel of the corrugated pipe as shown in FIG. 3 according to an exemplary disclosed embodiment;

FIG. 6 is a depiction of the sealing insert of FIG. 2A sealed within the ventilation channel of the corrugated pipe as shown in FIG. 3 according to an exemplary disclosed embodiment;

FIG. 7 is a further depiction of the sealing insert of FIG. 2A sealed within the ventilation channel of the corrugated pipe as shown in FIG. 3 according to an exemplary disclosed embodiment;

FIG. 8 is a further depiction of the sealing insert of FIG. 2A sealed within the ventilation channel of the corrugated pipe as shown in FIG. 3 according to an exemplary disclosed embodiment;

FIG. 9 is a depiction of the sealing insert of FIG. 2B inserted within the ventilation channel of the corrugated pipe as shown in FIG. 3 according to an exemplary disclosed embodiment; and

FIG. 10 is a depiction of the sealing insert of FIG. 2B sealed within the ventilation channel of the corrugated pipe as shown in FIG. 3 according to an exemplary disclosed embodiment.

### DETAILED DESCRIPTION

Reference will now be made in detail to the exemplary embodiments of the present disclosure described above and illustrated in the accompanying drawings.

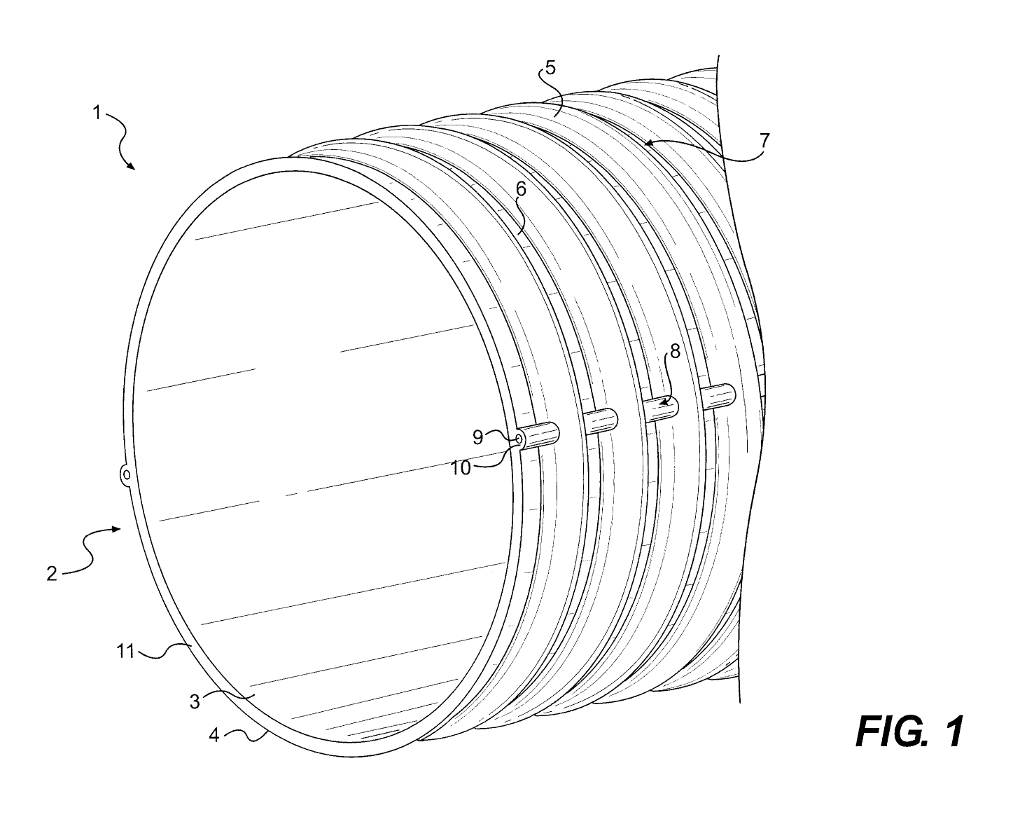

FIG. 1 illustrates a partial view of an exemplary corrugated pipe 1. Corrugated pipe 1 may be a dual-wall, corrugated pipe including an opening 2, an inner wall 3, and a corrugated outer wall 4. In one embodiment, inner wall 3 and corrugated outer wall 4 may be co-extruded using an extruder. Inner wall 3 and corrugated outer wall 4 then may be molded together by a corrugator. Alternatively, inner wall 3 may be separately fused to corrugated outer wall 4.

As illustrated in FIG. 1, inner wall 3 may be substantially smooth. Moreover, corrugated outer wall 4 may include a plurality of corrugation crests 5 and corrugation valleys 6. Corrugated outer wall 4 may also include a plurality of chambers 7, each defined by a respective primary corrugation crest 5 and inner wall 3.

In certain embodiments, corrugated pipe 1 may consist of this dual-wall, corrugated pipe (i.e., corrugated pipe 1 is defined by inner wall 3 and corrugated outer wall 4), as illustrated in FIG. 1. It should also be appreciated that this dual-wall corrugated pipe 1 may be passed through a downstream, cross-head die, which extrudes a second outer wall onto dual-wall pipe 1, thereby creating a three-wall corrugated pipe. Because the second outer wall would be extruded onto corrugated outer wall 4 while one or both of the second outer wall and corrugated outer wall 4 is still hot (i.e., in a melted or semi-melted state), the second outer wall may be fused or cohesively bonded to corrugation crests 5 of the corrugated outer wall 4.

Corrugated pipe 1 also may include one or more ventilations channels 8 integrally formed with corrugated outer wall 4 and inner wall 3. Ventilation channel 8 may be, for example, a hollow tubular member in fluid communication with each chamber 7 and may include a ventilation hole 9 having an outer periphery 10 defined by the radial surface the hollow tubular member. Ventilation channel 8 may be disposed along the length of corrugated pipe 1 and may terminate with ventilation hole 9 at a terminal end 11 of corrugated pipe 1. Therefore, each chamber 7 may be in fluid communication with the ambient air surrounding corrugated pipe 1 via ventilation channel 8. And, as hot air contained in each chamber 7 due to the extrusion process cools down, becoming more dense, deformation of corrugated outer wall 4 may be prevented because of the ventilation between each chamber 7 and its surrounding environment.

In the exemplary embodiment illustrated in FIG. 1, ventilation channel 8 may be a single, continuous tubular member parallel with a longitudinal axis of corrugated pipe 1 and extending through each of the plurality of chambers 7. In another embodiment, ventilation channel 8 may include a plurality of distinct tubular members, each in communication with adjacent chambers 7 and arranged in a staggered configuration relative to each other around an outer circumference of corrugated outer wall 4. In other words, ventilation channel 8 may include a plurality of distinct tubular members not aligned with each other along the length of corrugated pipe 1.

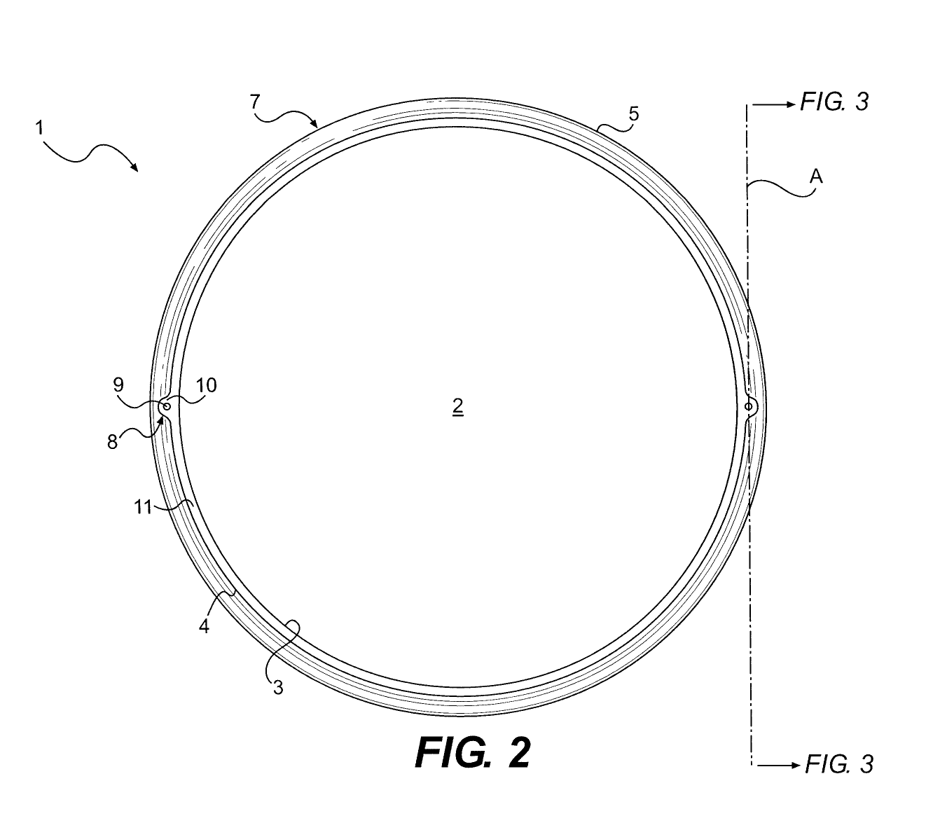

FIG. 2 illustrates a view of corrugated pipe 1, according to the exemplary embodiment illustrated in FIG. 1, from the perspective of terminal end 11 and into opening 2. As discussed above, each ventilation channel 8 may terminate at terminal end 11 with ventilation hole 9. Although two ventilation channels 8 are illustrated in FIG. 2, it should be appreciated that corrugation pipe 1 may include less or more than two ventilation channels 8. It also should be appreciated that in certain embodiments, a plurality of ventilation channels 8 may be disposed symmetrically around the outer circumference of corrugated outer wall 4, while in other embodiments, a plurality of ventilation channels 8 may be asymmetrically disposed around the outer circumference of corrugated outer wall 4.

FIG. 2 also illustrates that the width of ventilation channel 8 defined by inner wall 3 and corrugated outer wall 4 is less than the width of chambers 7 (i.e., the radial height of ventilation channel 8 is less than the radial height of corrugation crest 5). Such a configuration may provide a low profile for ventilation channel 8 to prevent accumulation of dirt, debris, and fluid on the corrugated outer wall 4 from a worksite. It also should be appreciated that the width of ventilation channel 8 may be substantially the same as the width of chambers 7, to provide a larger channel for improved ventilation.

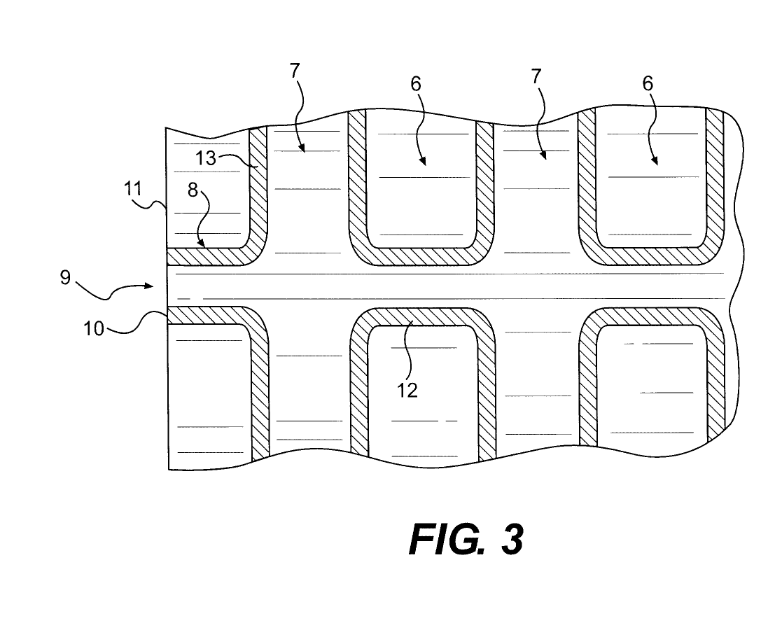

FIG. 3 illustrates a partial, cross-sectional depiction of corrugated pipe 1 along dashed line “A” of FIG. 2. As discussed above, ventilation channel 8 terminates at ventilation hole 9 at terminal end 11 of corrugated pipe 1. Terminal end 11 may be aligned with outer periphery 10 of ventilation hole 9. Ventilation channel 8 may be in fluid communication with each chamber 7 and may longitudinally extend between adjacent chambers 7, being positioned in valleys 6.

As depicted in FIG. 3, ventilation channel 8 may be integrally formed with each chamber 7. More particularly, a wall 12 of ventilation channel 8 may be integrally formed and contiguous with a wall 13 of chamber 7. It should also be appreciated that wall 12 of ventilation channel 8 may be formed of a different material than that of wall 13 of chamber 7 so as to vary the structural characteristics of each. For example, wall 13 of corrugation chamber 7 may be made of a more rigid, impact resistant plastic, while wall 12 of ventilation channel 8 may be made of a softer and more flexible plastic.

Although wall 12 of ventilation channel 8 and wall 13 of chamber 7 are illustrated as having substantially the same thickness, it should also be appreciated that wall 12 and wall 13 may have varying thickness to impart different structural rigidities and/or compliances between ventilation channel 8 and chamber 7.

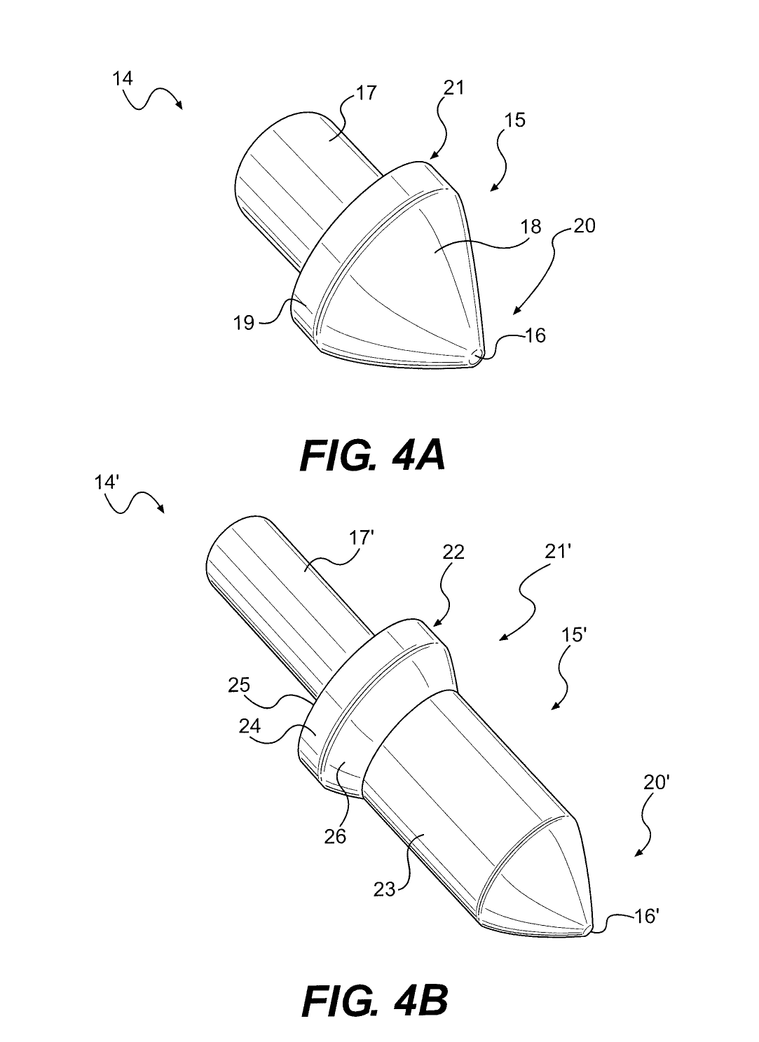

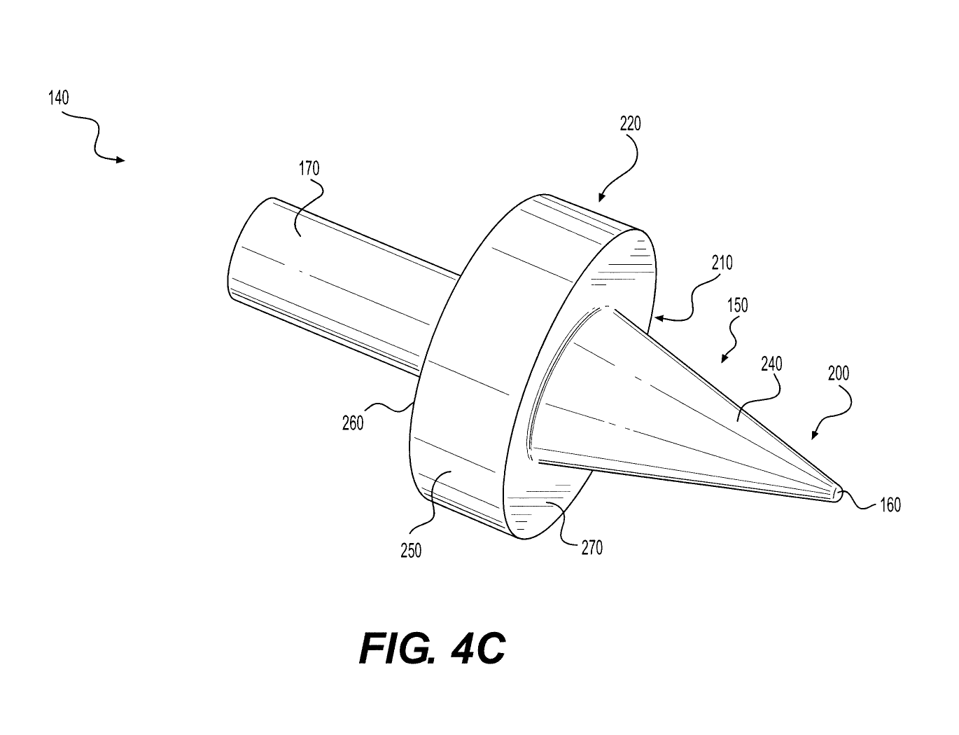

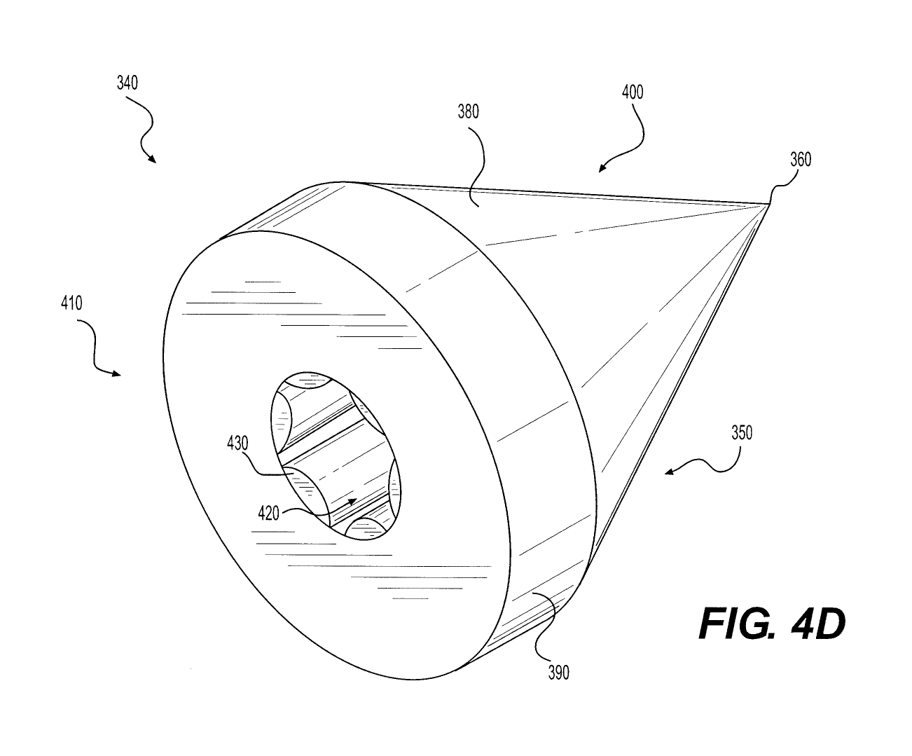

As will be discussed in more detail with respect to FIGS. 4A through 10, once corrugation pipe 1 has substantially cooled following the extrusion process, ventilation channel 8 may then be sealed with an appropriate sealing insert.

FIG. 4A illustrates an exemplary sealing insert 14 for sealing ventilation channel 8. Sealing insert 14 may include an insertion body 15 having a pointed tip 16 and a connecting member 17 coupled to insertion body 15. In one embodiment, sealing insert 14 may be injection molded or machined from a variety of plastic materials, such as polyethylene, polyvinyl chloride, polyester, polypropylene, polyamide, polyurethane, polystyrene, fluorine plastics, and the like. Sealing insert 14 may be a single piece of a material such that insertion body 15 and connecting member 17 may be continuously formed. Alternatively, insertion body 15 and connecting member 17 may be separate components formed from the same or different types of material. In such embodiments, connecting member 17 may be detachably engaged with insertion body 15 by a weld, adhesive, or the like.

Insertion body 15 may generally include a smooth, conical member 18 on a distal end 20 of insertion body 15, and transitioning to a smooth, cylindrical member 19 on a proximal end 21 of insertion body 15, as illustrated in FIG. 4A. Additionally, insertion body 15 may include a terminal width at proximal end 21 larger than the width of ventilation channel 8. It should also be appreciated that insertion body 15 may include ridges, cleats, spikes, nubs, or the like to enhance the engagement of sealing insert 14 into ventilation channel 8.

Pointed tip 16 may be defined on a distalmost end of insertion body 15 and may facilitate the entry of insertion body 15 into ventilation channel 8. Pointed tip 16 may include a sharp point, or alternatively, may include a flattened point.

Connecting member 17 may be configured to be coupled to a spinning mechanism (not shown), such as a mechanical power drill, air drill, or the like. In certain embodiments, connecting member 17 may be coupled to the spinning mechanism in a manner similar to a drill bit engaged with a power drill. As illustrated in FIG. 4A, connecting member 17 may be a smooth, cylindrical member having a width smaller than the terminal width of insertion body 15. In other embodiments, connecting member 17 may include a polygonal shape such that the outer surface of connecting member 17 may improve the connection of sealing insert 14 with the spinning mechanism.

FIG. 4B illustrates an exemplary embodiment of another sealing insert 14′. Sealing insert 14′ may include an insertion body 15′ having a pointed tip 16′, a capping portion 22, and a connecting member 17′ coupled to capping portion 22. In a similar manner as described above with regards to the embodiment of FIG. 4A, sealing insert 14′ may be injection molded or machined from a variety of plastic materials to form a single piece of continuous material. In certain other embodiments, connecting member 17′ may be a separate component from insertion body 15′ and capping portion 22 and may be formed of the same or a different type of material. In such embodiments, connecting member 17′ may be detachably engaged with capping portion 22 by a weld, adhesive, or the like.

As illustrated in the embodiment of FIG. 4B, insertion body 15′ may include a cylindrical body 23. Cylindrical body 23 may include an appropriate width larger than the width of ventilation channel 8. Although illustrated in FIG. 4B as having a substantially smooth outer surface, cylindrical body 23 may, in certain embodiments, include ridges, cleats, spikes, nubs, or the like, as described above with reference to the embodiment of FIG. 4A. Cylindrical body 23 may transition to pointed tip 16′ at a distal end 20′ of sealing insert 14′ and may be integrally formed with capping portion 22 at a proximal end 21′ of cylindrical body 23. Pointed tip 16′ also may facilitate the entry of insertion body 15′ into ventilation channel 8 and may include a sharp point, or alternatively, a flattened point.

Capping portion 22 may include a substantially disk-shaped member 24 having a flat surface 25 engaged with connecting member 17′ and a tapered surface 26 integrally formed with cylindrical body 23. Substantially disk-shaped member 24 may include a diameter larger than the width of cylindrical body 23. Moreover, the diameter of disk-shaped member 24 may be appropriately sized to “cap” ventilation hole 9 and cover outer periphery 10 of ventilation hole 9. Accordingly, sealing insert 14′ may provide a surface for sealing ventilation channel 8, external to ventilation channel 8, via capping portion 22, in addition to the sealing surface within ventilation channel 8 provided by insertion body 15′.

In addition, tapered surface 26 of sealing insert 14′ may provide a tighter interface between sealing insert 14′ and ventilation channel 8 at ventilation hole 9. That is, the angled configuration of tapered surface 26 may wedge against wall 12 of ventilation channel 8 at ventilation hole 9.

Similar to the embodiment of FIG. 4A, connecting member 17′ also may be coupled to an appropriate spinning mechanism. Likewise, connecting member 17′ also may be a smooth, cylindrical member, or in certain embodiments, include a polygonal shape.

FIG. 4C illustrates an exemplary embodiment of yet another sealing insert 140. Sealing insert 140 may include an insertion body 150 having a pointed tip 160, a capping portion 220, and a connecting member 170 coupled to capping portion 220. In some embodiments, sealing insert 140 may be injection molded or machined from a variety of plastic materials to form a single piece of a continuous material. In certain other embodiments, connecting member 170 may be a separate component from insertion body 150 and capping portion 220, wherein connecting member 170 may be detachably engaged with capping portion 220 via a weld, adhesive, or the like. Connecting member 170 also may be coupled to an appropriate spinning mechanism.

Insertion body 150 may include a conical member 240. Conical member 240 may include a width larger than the width of ventilation channel 8. For example, the portion of conical member 240 terminating at capping portion 220 may be wider than the width of ventilation channel 8. Further, conical member 240 may transition to pointed tip 160 at a distal end 200 of sealing insert 140 and may be integrally formed with capping portion 220 at a proximal end 210 of conical member 240.

Capping portion 220 may include a cylindrical member 250 having a first substantially flat surface 260 engaged with connecting member 170 and a second substantially flat surface 270 integrally formed with conical member 240. Cylindrical member 250 may include a diameter larger than the width of conical member 240. Further, the diameter of cylindrical member 250 may be appropriately sized to “cap” ventilation hole 9 and cover outer periphery 10 of ventilation hole 9. In particular, second substantially flat surface 270 may abut against outer periphery 10 and form a substantially flat connection interface. Accordingly, sealing insert 140 may provide a surface for sealing ventilation channel 8, external to ventilation channel 8, via capping portion 220, in addition to the sealing surface within ventilation channel 8 provided by insertion body 150.

FIG. 4D illustrates an exemplary embodiment of another sealing insert 340. Sealing insert 340 may include an insertion body 350 having a pointed tip 360. Sealing insert 340 may be injection molded or machined from a variety of plastic materials.

Insertion body 350 may generally include a conical member 380 on a distal end 400 of insertion body 350, and transitioning to a smooth, cylindrical member 390 on a proximal end 410 of insertion body 350, as illustrated in FIG. 4D. Additionally, insertion body 350 may include a terminal width at proximal end 410 larger than the width of ventilation channel 8. Pointed tip 360 may be defined on a distalmost end of insertion body 350 and may facilitate the entry of insertion body 350 into ventilation channel 8. Pointed tip 360 may include a sharp point, or alternatively, may include a flattened point.

Insertion body 350 may also include a connection port 420 at proximal end 410 of insertion body 350. Connection port 420 may be configured to facilitate the connection of a bit, rod, or the like associated with a spinning mechanism. In such an embodiment, the bit or rod of the spinning mechanism, serving as a connecting member to sealing insert 340, may be readily detached from insertion body 350. That is, once insertion body 350 has been sealed into ventilation channel 8, the bit or rod of the spinning mechanism may be removed from connection port 420. As illustrated in FIG. 4D, connection port 420 may include a plurality of ridges 430 configured to strengthen the grip and connection of insertion body 420 to the bit or rod of the connecting member.

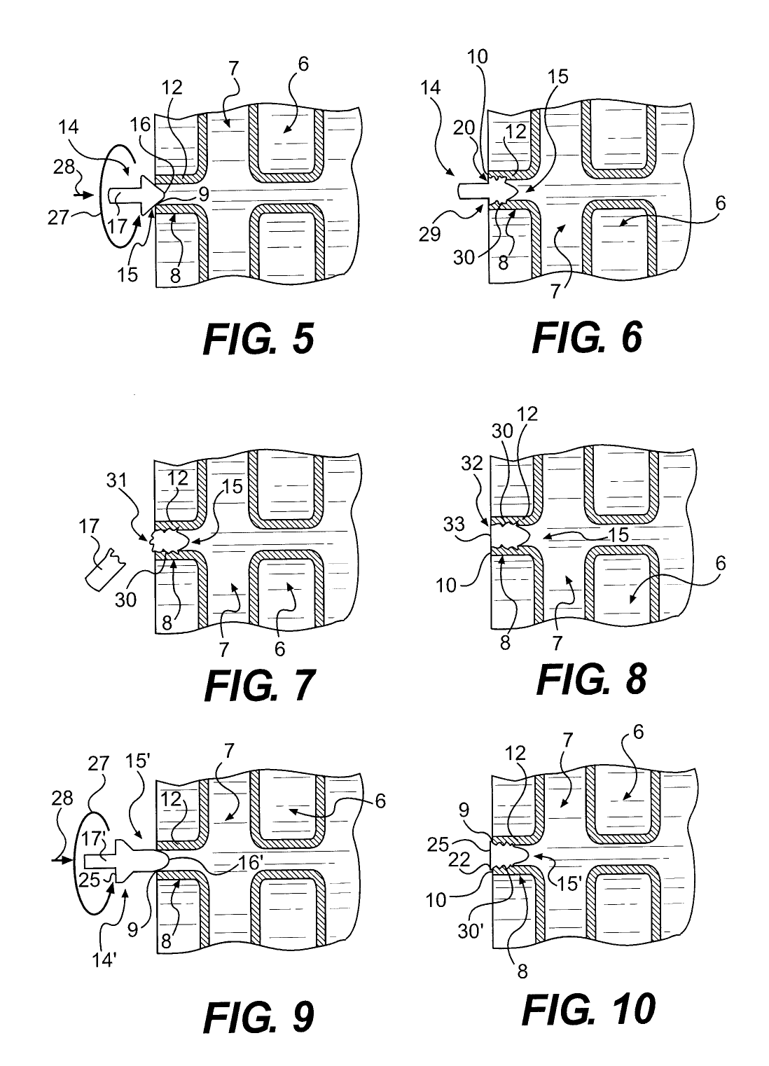

FIGS. 5-8 depict an exemplary method of sealing ventilation channel 8 of corrugated pipe 1 with sealing insert 14 in the perspective of an exemplary cross-section of corrugated pipe 1 illustrated in FIG. 3. Additionally, FIGS. 9-10 illustrate the application of sealing insert 14′ for sealing ventilation channel 8 in a substantially similar manner as will be described below with regards to FIGS. 5-8.

Sealing insert 14 first may be coupled to the appropriate spinning mechanism. Then, and as depicted in the exemplary embodiment of FIG. 5, pointed tip 16 of sealing insert 14 may be inserted into ventilation channel 8 through ventilation hole 9. Slight forward pressure may be applied to sealing insert 14 to set and position at least a portion of insertion body 15 within ventilation channel 8. In some embodiments, ventilation hole 9 may be widened by removing excess extruded material via drilling, cutting, or any other appropriate means prior to inserting sealing insert 14 into ventilation channel 8. Such a step may provide an appropriately sized ventilation hole 9 and fit for sealing insert 14.

As illustrated in FIG. 5, once at least a portion of insertion body 15 is disposed within ventilation channel 8, the spinning mechanism may then be activated. Activation of the spinning mechanism may translate clockwise rotational energy 27 to sealing insert 14 causing insertion body 15 to rotate against wall 12 of ventilation channel 8. Heat created by the rotational friction between insertion body 15 and wall 12 of ventilation channel 8 may begin to slightly melt and mold together the materials of insertion body 15 and wall 12. In addition to the rotational energy applied to sealing insert 14, axial force 28 also may be applied thereto (i.e., sealing insert 14 may be pushed forward) to facilitate the advancement of insertion body 15 into ventilation channel 8.

FIG. 6 illustrates an exemplary cross-sectional embodiment of sealing insert 14 welded into ventilation channel 8. Once sealing insert 14 reaches a predetermined, threshold position 29, for example, when distal end 20 of insertion body 15 sits flush with outer periphery 10 of ventilation hole 9, the spinning mechanism may be deactivated. Sealing insert 14 and the spinning mechanism may then be held in place for an appropriate amount of time to allow the melted materials of insertion body 15 and wall 12 of ventilation channel 8 to cool and weld together. The cooled materials accordingly may form a fluid-tight weld interface 30 between insertion body 15 and wall 12 of ventilation channel 8. Therefore, sealing insert 14 may seal ventilation channel 8 from the surrounding environment of corrugated pipe 1. After sufficient time has elapsed for insertion body 15 to weld into ventilation channel 8, sealing insert 14 may be inspected to test the adequacy of the weld. For example, sealing insert 14 may be pushed, pulled, twisted, or examined via any other appropriate range of motion to ensure that sealing insert 14 is securely welded within ventilation channel 8. If, for example, sealing insert 14 is loose, sealing insert 14 may be removed and a replacement sealing insert having, for example, a larger terminal width, may be spin welded into ventilation channel 8.

It should also be appreciated that ventilation channel 8 may be sealed by a friction fit between sealing insert 14 and wall 12 of ventilation channel 8. In such embodiments, sealing insert 14 may be gradually advanced into ventilation channel 8 by a sustained and low axial force or a sustained and low rotational force. The friction fit between sealing insert 14 and ventilation channel 8 may allow for removal of sealing insert 14, if necessary.

FIG. 7 illustrates an exemplary cross-sectional embodiment of sealing insert 14 welded within ventilation channel 8 and having connecting member 17 detached from insertion body 15. If it has been determined that sealing insert 14 is adequately secured within ventilation channel 8, connecting member 17 may be sheared off insertion body 15. In one embodiment, the deactivated spinning mechanism may be rotated clockwise such that connecting member 17 detaches from insertion body 15, with connecting member 17 remaining coupled to the spinning mechanism. In other embodiments, the spinning mechanism may be decoupled from connecting member 17, and connecting member 17 then may be cut or cleaved off insertion body 15 by any known means.

As discussed above, in certain embodiments, connecting member 17 may be detachably secured to insertion body 15 by certain known adhesive means. Additionally, connecting member 17 may include perforations or the like along the interface between connecting member 17 and insertion body 15 to facilitate detachment therebetween. In such embodiments, separation of connecting member 17 and insertion body 15 may leave a relatively smooth surface on insertion body 15 where connecting member 17 originally was engaged. Moreover, the aforementioned detachable arrangement between insertion body 15 and connecting member 17 may provide a quick and less difficult disassembly of insertion body 15 from the spinning mechanism, as connecting member 17 may be readily detached from insertion body 15.

In embodiments where sealing insert 14 may be formed from a single piece of continuous material, as illustrated in FIGS. 5-7, sealing insert 14 may have improved connection strength between insertion body 15 and connecting member 17. However, and as illustrated in FIG. 7, shearing connection member 17 from insertion body 15 may leave behind rough surface 31, for example, on insertion body 15. In some embodiments, it may then be desirable to remove rough surface 31, as illustrated in FIG. 8.

FIG. 8 illustrates an exemplary, cross-sectional embodiment of sealing insert 14 having a flush interface 32 with terminal end 11 of corrugated pipe 1. The aforementioned rough surface 31 may be deburred, sanded, abraded, or the like, to form flush interface 32. Flush interface 32 may be a smoothed surface 33 substantially aligned with outer periphery 10 of ventilation hole 9. Flush interface 32 therefore may provide unobstructed connections between multiple corrugation pipes 1 at their terminal ends 11.

FIG. 9 illustrates an exemplary, cross-sectional embodiment of sealing ventilation channel 8 of corrugated pipe 1 with sealing insert 14′. In a similar manner as discussed about with regards to FIGS. 5-8, sealing insert 14′ may be spin welded to wall 12 of ventilation channel 8.

Furthermore, and as illustrated in FIG. 10, insertion body 15′ may similarly form a fluid-tight weld interface 30′ with wall 12 of ventilation channel 8, as in the embodiments of FIGS. 6-8. Moreover, connecting member 17′ may be detached from capping portion 22, and any rough or unsmooth surfaces remaining on capping portion 22 due to the removal of connecting member 17′ may be treated to make smooth flat surface 25, in a similar manner as discussed above with regards to FIGS. 7-8.

As shown in FIG. 10, capping portion 22 may “cap” ventilation hole 9 by extending radially along outer periphery 10 of ventilation hole 9. Thus, the engagement of capping portion 22 to outer periphery 10 may provide additional surface area for sealing ventilation channel 8 and may serve to barricade external ventilation hole 9.

As will be appreciated by one of ordinary skill in the art, the presently disclosed corrugated pipe, sealing insert, and methods may enjoy numerous advantages over previously known corrugated pipes. First, because sealing insert 14, 14′, 140, 340 is adapted to be readily utilized with common spinning mechanisms, such as a mechanical drill, ventilation channel 8 may be easily and quickly sealed immediately after corrugated pipe 1 has cooled down from the molding process. Additionally, the general compatibility between sealing insert 14, 14′, 140, 340 and common spinning mechanisms provides eased transportation to and installation at a jobsite. For example, a sealing kit including a plurality of sealing inserts having various sizes may be readily transported to the jobsite. At the jobsite, an installer may inspect ventilation channel and choose an appropriately sized sealing insert from the kit. The installer then may employ the spinning mechanism to spin weld the appropriate sealing insert into ventilation channel 8. Furthermore, connecting member 17, 17′, 170 provides a readily engageable linkage to the spinning mechanism for installation of sealing insert 14, 14′, 140 while also providing a readily detachable linkage once sealing insert 14, 14′, 140 has been appropriately sealed within ventilation channel 8, by, for example, shearing or cleaving connecting member 17, 17′, 170 from insertion body 15 or capping portion 22, 220. Connection port 420 provides a readily detachable linkage between insertion body 350 and a bit or rod of a spinning mechanism.

Moreover, spin welding sealing insert 14, 14′, 140, 340 within ventilation channel 8 provides an effective seal without the need for prolonged drying times and/or dry conditions often associated with adhesives and other welding applications. Further, since the bond between sealing insert 14, 14′, 140, 340 and ventilation channel 8 includes welding together wall 12 material and insertion body 15, 15′, 150, 350 material, ventilation channel 8 is enclosed from its outside environment by a stronger fluid-tight seal. Such a fluid-tight seal is resistant to disassembly due to deterioration and degradation from external forces and elements, such as fluids, dirt, and debris, from a jobsite.

The many features and advantages of the present disclosure are apparent from the detailed specification, and thus, it is intended by the appended claims to cover all such features and advantages of the present disclosure which fall within the true spirit and scope of the present disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

What is claimed is:

1. A method of sealing a ventilation channel for a pipe, the method comprising:
inserting a sealing insert into a ventilation hole of the ventilation channel;
applying rotational energy to the sealing insert;
deactivating the rotational energy to the sealing insert once the sealing insert reaches a threshold position; and
separating a first portion of the sealing insert being inserted in the ventilation channel from a second portion of the sealing insert.

2. The method of claim 1, further including forming a flush interface between the sealing insert and the pipe.

3. The method of claim 1, further including securing the sealing insert within the ventilation channel.

4. The method claim 3, wherein securing the sealing insert includes forming a weld between the sealing insert and a wall of the ventilation channel.

5. The method of claim 3, wherein securing the sealing insert includes forming a friction fit between the sealing insert and a wall of the ventilation channel.

6. The method of claim 1, further including providing forward pressure to the sealing insert as rotational energy is applied to the sealing insert.

7. The method of claim 1, further including engaging the sealing insert with an outer periphery of the ventilation hole.

8. The method of claim 1, wherein separating the first portion of the sealing insert from the second portion of the sealing insert, further includes shearing the second portion of the sealing insert off the first portion of the sealing insert.

9. The method of claim 1, wherein the pipe is a corrugated pipe.

10. The method of claim 9, wherein the ventilation channel is fluidly coupled to a plurality of corrugations of the corrugated pipe.

11. The method of claim 1, further including widening the ventilation hole prior to inserting the sealing insert into the ventilation hole.

12. A corrugated pipe, comprising:
an inner wall;
an outer wall including a plurality of corrugations;
a ventilation channel formed between the inner wall and the outer wall; and
a sealing insert secured within the ventilation channel, the sealing insert configured to fluidly seal the ventilation channel.

13. The corrugated pipe of claim 12, wherein the ventilation channel is in fluid communication with each of the plurality of corrugations.

14. The corrugated pipe of claim 13, wherein the ventilation channel is integrally formed with the inner wall and the outer wall and extends through each of the plurality of corrugations.

15. The corrugated pipe of claim 14, wherein the ventilation channel includes a ventilation hole defined on a terminal end of the corrugation pipe.

16. The corrugated pipe of claim 15, wherein the sealing insert is advanced through the ventilation hole and is secured within the ventilation channel by a friction fit.

17. The corrugated pipe of claim 15, wherein the sealing insert is advanced through the ventilation hole and is secured within the ventilation channel by a weld formed between the sealing insert and a wall of the ventilation channel.

18. The corrugated pipe of claim 12, further including a flush interface between the sealing insert and the corrugated pipe.

19. The corrugated pipe of claim 17, wherein the sealing insert engages an outer periphery of the ventilation hole.

20. A method for manufacturing a pipe, the method comprising:
co-extruding an inner pipe wall and a corrugated outer pipe wall from a mold to form a corrugated pipe, the corrugated outer pipe wall including a plurality of corrugations;
forming a ventilation channel extending through and in communication with each of the plurality of corrugations, the ventilation channel including at least one ventilation hole;
releasing the corrugated pipe from the mold; and
sealing the ventilation channel by securing a sealing insert within the ventilation channel after the corrugated pipe is released from the mold.

21. The method of claim 20, wherein securing the sealing insert includes spin welding the sealing insert into the ventilation channel.

22. The method of claim 21, further including separating a first portion of the sealing insert secured in the ventilation channel from a second portion of the sealing insert.

23. The method of claim 22, further including shearing the second portion of the sealing insert off the first portion of the sealing insert.

24. The method of claim 20, wherein securing the sealing insert includes forming a friction fit between the sealing insert and the ventilation channel.

25. The method of claim 20, further including forming a flush interface between the sealing insert and the corrugated pipe.
